(19) United States
(12) Patent Application Publication
(10) Pub. No.: US 2009/0171812 A1
(43) Pub. Date: Jul. 2, 2009

(54) Media streams and media store

(75) Inventor: Anthony Fadell, Portola Valley, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/075,831

(22) Filed: Mar. 14, 2008

Related U.S. Application Data
(60) Provisional application No. 61/018,149, filed on Dec. 31, 2007.

(51) Int. Cl. G06Q 30/00

(52) U.S. Cl. 705/27

(57) ABSTRACT

This invention is directed to providing access to one or more media streams in exchange for purchasing articles or items that may be related to at least one of the media streams. In some embodiments, the item purchased may include a media item related to a media item provided as part of a particular media stream. For example, a user may be provided access to an Internet radio station in exchange for purchasing a song. The song may include any song available from a store, a song transmitted by the Internet radio station, or a song related to a song transmitted by the Internet radio station. Each media item purchased may provide the user with a particular amount of media stream credit that may be used to access media streams. In some embodiments, different purchased media items may provide the user with the same or different amounts of credit.

### CROSS-REFERENCE TO RELATED APPLICATIONS

This application claims the benefit of prior filed U.S. Provisional Patent Application No. 61/018,149, filed Dec. 31, 2007 (Attorney Docket No. 104677-0182-001 (P5587USP1)), which is incorporated by reference herein in its entirety.

### BACKGROUND OF THE INVENTION

This invention is directed to an application for providing access to media streams, such as Internet radio streams in exchange for purchasing media items, for example media items transmitted as part of the media streams.

A number of approaches may be used to provide users with access to media content, such as for example music, videos, images, and other media content. A first approach may include allowing users to purchase a personal copy, or a license to a personal copy of a media item in exchange for a determined fee. For example, a user may pay a first flat rate (e.g., $0.99) in exchange for one song, and a second flat rate (e.g., $9.99) in exchange for an album. If the user terminates his account with the seller of the media, the user nevertheless is permitted to keep his copies of the purchased media (e.g., a pay model).

A second approach may include providing access to an unlimited number of media items in exchange for a regularly assessed fee. For example, in exchange for a monthly fee, a user may have access to an entire catalogue of music. At the end of each month, the user must pay the fee again, or loses access to the entire catalogue. When the user terminates his account with the seller of the media, the user does not own or have a right to any media that was not previously owned (e.g., a subscription model).

In some cases, instead of allowing the user to select which media item to play back from the entire catalogue, the media provider may elect to transmit particular media items in an order and at intervals defined by the media provider as a media stream. The user may then pay a tax for access to the media stream. In some embodiments, the user may even be provided with limited playback control of the media stream (e.g., the ability to skip media items, but not to go back to prior transmitted media items). For example, a media provider may transmit an Internet radio stream, which a user may access in exchange for the tax. The tax may be levied in any suitable manner, including for example as a regular fee (e.g., a monthly fee), or using advertisements (e.g., the media provider may transmit one or more advertisements between every 3 or 5 media items).

### SUMMARY OF THE INVENTION

This invention is directed to systems and methods for providing access to media streams using pay model features. An application for providing media streams may be provided. For example, an application for providing Internet radio streams may be provided. The user of the application may receive access to the media streams in exchange for a tax. The tax may be levied using several different approaches. Using one approach, the user may directly pay for access to the media streams. For example, the user may pay a monthly fee for access to the media streams. Using a second approach, the user may pay for access to the media streams by listening to advertisements provided by the media provider. For example, the media provider may incorporate one or more advertisements at different intervals of the media stream (e.g., in between successive media items transmitted as part of the media stream).

In some embodiments, the media application may assess the tax by tying access to the media stream to the purchase of an article or item. For example, in exchange for the purchase of apparel related to the media stream (e.g., a t-shirt with the name of the Internet radio channel), the user may be allowed access to the media stream. As another example, the user may be provided with access to the media stream in exchange for purchasing (e.g., using a pay model) a media item, such as a media item currently transmitted by the media stream, or a media item related to the currently transmitted media item.

Each article or media item purchased may provide the user with a particular amount of media stream credit that corresponds to a particular amount of access to a media stream. Each purchased article or media item may provide the user with the same or different amounts of media stream credit. Any suitable criteria may be used to determine how much credit to associate with a particular purchased article or media item. For example, the amount of credit may be related to one or more of the price of the article or media item purchased, the duration of the media item, how closely related the purchase is to the media stream, the user's settings (e.g., VIP user or not), or any other suitable criteria.

In some embodiments, the application may provide different prices for the same article or media item, depending on whether or not the purchase provides the user with media stream credit. For example, purchases that include media stream credit may be more expensive than purchases that don't (e.g., access to more media is provided). As another example, purchases that include media stream credit may be less expensive than purchases that don't (e.g., media streams provide advertisements for purchasing more media items and facilitate impulse ordering).

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is a schematic view of a communications system in accordance with one embodiment of the invention;

FIG. 2 is a schematic view of a electronic device in accordance with one embodiment of the invention;

FIG. 3 is an illustrative display screen of an application for streaming media in accordance with one embodiment of the invention;

FIG. 4 is an illustrative display screen for purchasing a media item in exchange for access to a media stream in accordance with one embodiment of the invention;

FIG. 5 is a flowchart of an illustrative process for accessing a media stream in accordance with one embodiment of the invention; and

FIG. 6 is a flowchart of an illustrative process for purchasing access to a media stream in accordance with one embodiment of the invention.

### DETAILED DESCRIPTION

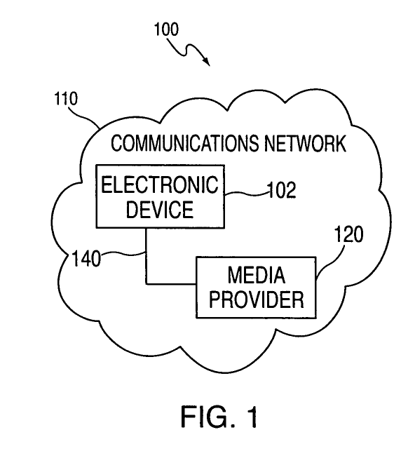

FIG. 1 is a schematic view of a communications system in accordance with one embodiment of the invention. Communications system 100 may include electronic device 102 and communications network 110, which electronic device 102 may use to perform wireless communications with other devices within communications network 110. For example, electronic device 102 may receive media or other data from media provider 120 over communications network 110. Although communications system 100 may include several electronic devices 102 and media providers 120, only one of each is shown in FIG. 1 to avoid overcomplicating the drawing.

Any suitable circuitry, device, system or combination of these (e.g., a wireless communications infrastructure including communications towers and telecommunications servers) operative to create a communications network may be used to create communications network 110. Communications network 110 may be capable of providing wireless communications using any suitable short-range or long-range communications protocol. In some embodiments, communications network 110 may support, for example, Wi-Fi (e.g., a 802.11 protocol), Bluetooth®, high frequency systems (e.g., 900 MHz, 2.4 GHz, and 5.6 GHz communication systems), infrared, other relatively localized wireless communication protocol, or any combination thereof. In some embodiments, communications network 110 may support protocols used by wireless and cellular phones and personal email devices (e.g., a Blackberry®). Such protocols can include, for example, GSM, GSM plus EDGE, CDMA, quadband, and other cellular protocols. In another example, a long range communications protocol can include Wi-Fi and protocols for placing or receiving calls using VoIP or LAN. Paths between devices and providers within communications network 110 may include any suitable paths, including for example Internet paths.

Electronic device 102 may include any suitable device for receiving media or data. For example, electronic device 102 may include a media player such as an iPod available by Apple Inc., of Cupertino, Calif., a cellular telephone, a personal e-mail or messaging device (e.g., a Blackberry® or a Sidekick®), an iPhone available from Apple Inc., pocket-sized personal computers such as an iPAQ Pocket PC available by Hewlett Packard Inc., of Palo Alto, Calif., personal digital assistants (PDAs), a desktop computer, a laptop computer, and any other device capable of communicating with a media provider (e.g., wirelessly or using a wired connection). The communications sent and received may include any suitable form of communications, including for example, voice communications (e.g., telephonic communications), data communications (e.g., e-mails, text messages, media messages), or combinations of these.

Electronic device 102 may be coupled with media provider 120 over communications link 140 using any suitable approach. For example, electronic device 102 may use any suitable wireless communications protocol to connect to media provider 120 over communications link 140. As another example, communications link 140 may be a wired link that is coupled to both electronic device 102 and media provider 120 (e.g., an Ethernet cable). As still another example, communications link 142 may include a combination of wired and wireless links (e.g., an accessory device for wirelessly communicating with media provider 120 may be coupled to electronic device 102). In some embodiments, any suitable connector, dongle or docking station may be used to couple electronic device 102 and media provider 120 as part of communications link 140.

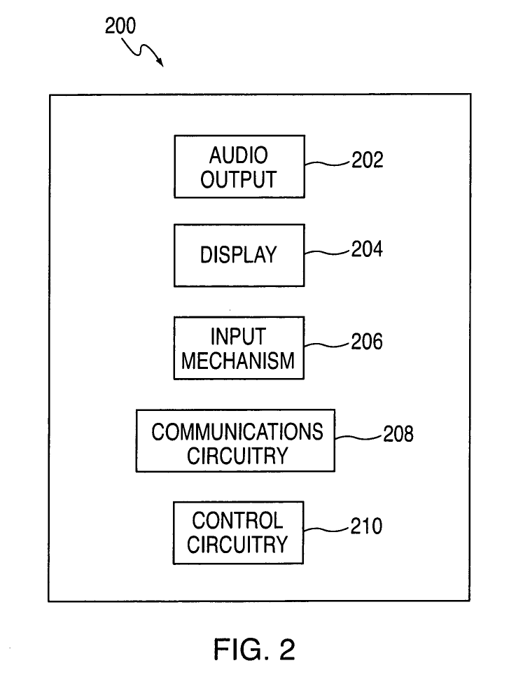

FIG. 2 is a schematic view of a electronic device in accordance with one embodiment of the invention. Electronic device 200 may include audio output 202, display 204, input mechanism 206, communications circuitry 208 and control circuitry 210.

Audio output 202 may include any suitable audio component for providing audio to the user of electronic device 200. For example, audio output 202 may include one or more speakers (e.g., mono or stereo speakers) built into electronic device 200. In some embodiments, audio output 202 may include an audio component that is remotely coupled to electronic device 200. For example, audio output 202 may include a headset, headphones or earbuds that may be coupled to electronic device with a wire (e.g., coupled to electronic device 200 with a jack) or wirelessly (e.g., Bluetooth® headphones or a Bluetooth® headset).

Display 204 may include any suitable screen or projection system for providing a display visible to the user. For example, display 204 may include a screen (e.g., an LCD screen) that is incorporated in electronic device 200. As another example, display 204 may include a movable display or a projecting system for providing a display of content on a surface remote from electronic device 200 (e.g., a video projector). Display 204 may be operative to display content (e.g., information regarding ongoing communications operations, information regarding incoming communications requests, media, or device operation screens) under the direction of control circuitry 210.

Input mechanism 206 may include any suitable mechanism for providing user inputs or instructions to electronic device 200. Input mechanism 206 may take a variety of forms, such as a button, keypad, dial, a click wheel, or a touch screen. The user interface may include a multi-touch screen such as that described in U.S. Pat. No. 6,323,846, which is incorporated by reference herein in its entirety. The user interface may emulate a rotary phone or a multi-button keypad, which may be implemented on a touch screen or the combination of a click wheel or other user input device and a screen. A more detailed discussion of such a rotary phone interface may be found, for example, in U.S. patent application Ser. No. 11/591,752, filed Nov. 1, 2006, entitled “Touch Pad with Symbols based on Mode,” which is incorporated by reference herein in its entirety.

Communications circuitry 208 may include any suitable communications circuitry operative to connect to a communications network (e.g., communications network 110, FIG. 1) and to transmit communications (e.g., voice or data) from electronic device 200 to other devices within the communications network. Communications circuitry 208 may be operative to interface with the communications network using any suitable communications protocol such as, for example, Wi-Fi (e.g., a 802.11 protocol), Bluetooth®, high frequency systems (e.g., 900 MHz, 2.4 GHz, and 5.6 GHz communication systems), infrared, GSM, GSM plus EDGE, CDMA, quadband, and other cellular protocols, VoIP, or any other suitable protocol. In some embodiments, communications circuitry 208 may be operative to receive media or data over the Internet (e.g., streaming media or downloaded media).

In some embodiments, communications circuitry 208 may be operative to create a communications network using any suitable communications protocol. For example, communications circuitry 208 may create a short-range communications network using a short-range communications protocol to connect to other devices. For example, communications circuitry 208 may be operative to create a local communications network using the Bluetooth® protocol to couple electronic device 208 with a Bluetooth® headset.

Electronic device 200 may include one more instances of communications circuitry 208 for simultaneously performing several communications operations with different devices or providers, and using different communications networks, although only one of each is shown in FIG. 2 to avoid overcomplicating the drawing. For example, electronic device 200 may include a first instance of communications circuitry 208 for communicating over a cellular network, and a second instance of communications circuitry 208 for communicating over Wi-Fi or using Bluetooth. In some embodiments, the same instance of communications circuitry 208 may be operative to provide for communications over several communications networks.

Control circuitry 210 may be operative to control the operations and performance of electronic device 200. Control circuitry 210 may include, for example, a processor, a bus (e.g., for sending instructions to the other components of electronic device 200), memory, storage, or any other suitable component for controlling the operations of electronic device 200. In some embodiments, a processor may drive the display and process inputs received from the user interface. The memory and storage may include, for example, cache, Flash, ROM, and/or RAM. In some embodiments, memory may be specifically dedicated to storing firmware (e.g., for device applications such as an operating system, user interface functions, and processor functions).

Control circuitry 210 may be operative to execute instructions provided by firmware, software, or both implemented in electronic device 200. For example, control circuitry 210 may be operative to execute instructions provided by a media streaming application, such as a radio application or a video application. As another example, control circuitry 210 may be operative to execute instructions provided by a communications application (e.g., an email or telephone application, or a remote access application), word processing application, a media playback application (e.g., a music, radio or video playback application), a system utility, a location-detection application, or any other suitable application for controlling operations of the electronic device.

Electronic device 200 may include any other component suitable for performing communications operations. For example, electronic device 200 may include a power supply, ports or interfaces for coupling to a host device, a secondary input mechanism (e.g., an ON/OFF switch), or any other suitable component.

In some embodiments, the electronic device may be operative to receive and output media streamed from a media provider over a communications link, such as for example over the Internet. For example, radio signals or videos (e.g., video clips or television programming) may be received using any suitable approach, including for example over the Internet, as a media stream. The electronic device may perform any suitable operation upon receiving the media stream. For example, the electronic device may, automatically or in response to a user instruction, cache the received stream for immediate (e.g., online) or future (e.g., offline) playback.

The streamed media may include any suitable media, including for example media available for free to the user of the electronic device, and other media available in exchange for a tax. The user of the electronic device may pay the tax for access to streamed media using any suitable approach. For example, the user may purchase access to the streamed media on a per media item basis (e.g., purchase model for media). As another example, the user may purchase access to the media stream on a per unit of time basis (e.g., subscription model for media). The currency, consideration or tax provided by the user for access to the streamed media may include any suitable tax, including for example money (e.g., purchasing access to a particular duration of a media stream) or time (e.g., by forcing the user to view a particular quantity of advertisements for access to a particular amount of streamed media).

In some embodiments, the electronic device may selectively receive access to streamed media in exchange for the user of the electronic device purchasing articles or items (i.e., instead of directly purchasing access to the streamed media). For example, the electronic device may receive access to streamed media in exchange for the user purchasing a particular media item (e.g., receive access to an Internet radio stream in exchange for the user purchasing a song transmitted by the Internet radio station). As another example, the electronic device may receive access to streamed media in exchange for the user purchasing a particular product (e.g., a product that was advertised, a product related to the media of the media stream, or a product related to the media provider).

The tax may allow any suitable type of access right to streamed media. For example, the tax may allow the user to access a particular amount of streamed media (e.g., a duration of playback, a number of times the media is accessed, or a number of times a particular song may be played back) in exchange for payment of the tax. Although the following display screens and discussion describe the media streams in the context of Internet radio, and purchased article or item in the context of a media item, it will be understood that the described embodiments may be applied to any suitable media stream, article, or item.

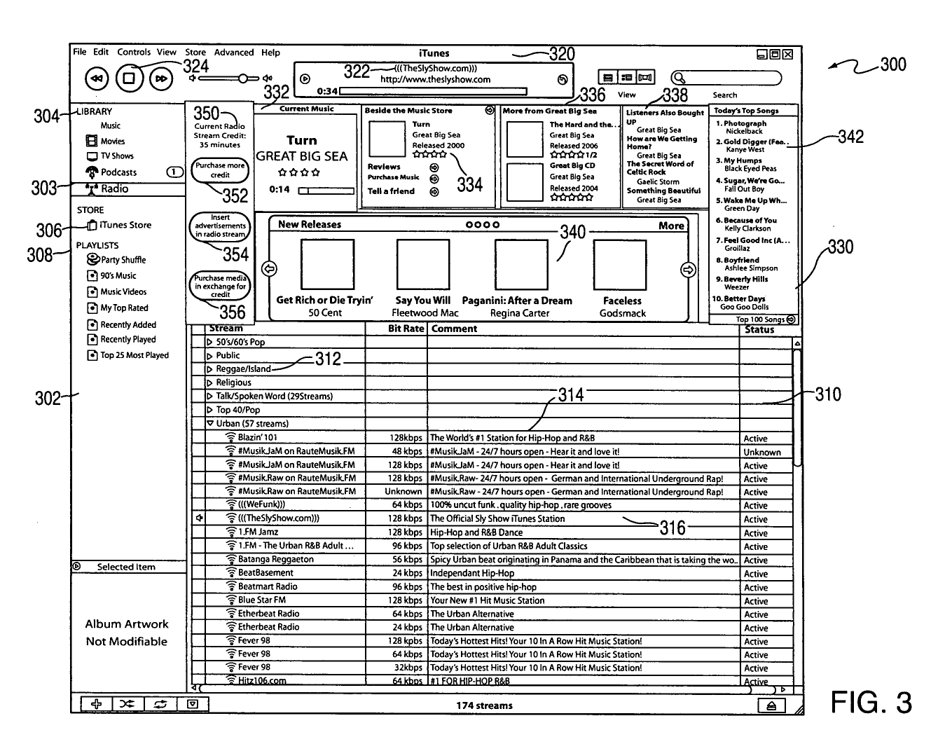

FIG. 3 is an illustrative display screen of an application for streaming media in accordance with one embodiment of the invention. Display screen 300 may include navigation panel 302, media panel 310, and media access panel 330. Navigation panel 302 may include several options for selecting different types of media available for playback to the user. For example, navigation panel 302 may include library options 304, store option 306 and playlists options 308. The user may select any suitable option from navigation panel 302 using highlight region 303. An option for accessing streaming media may be displayed in any of library options 304, store option 306 and playlists options 308. In the example of FIG. 3, library options 304 include a radio option that the user may select to access audio streams over the Internet (e.g., as Internet radio).

In response to receiving a user selection of an option from navigation panel 302, the application may display content related to the selected option in media panel 310 and media access panel 330. Media panel 310 may include listings 314 of available media associated with the option selected from navigation panel 302. In the example shown in FIG. 3, in response to a user selection of a radio option in navigation panel 302, media panel 310 may include listings 314 of radio channels available for access by the user. The displayed listings may be organized using any suitable approach. In some embodiments, listings 314 may be organized in categories 312. For example, categories 312 may include types or genres of radio stations that the user may select. In response to receiving a selection of a particular category 312, media panel 310 may display listings 314 of available media associated with the selected particular category 312.

The user may select particular media to display from listings 314 using highlight region 316. In response to receiving a user selection of particular media, the application may play back the selected media and provide an output (e.g., audio or video) for the selected media. The application may identify the currently output media using any suitable approach, including for example in playback control panel 320. Playback control panel 320 may include window 322 in which the application may display the name of the selected media (e.g., the name of the radio station), the current playback position (e.g., how long the media has been streaming), or any other suitable information. The user may control the playback of the media using playback control options 324. If the media selected in listing 314 includes a media stream, the application may stream the selected media and provide an output for the received media stream. In some embodiments, the application may first determine whether the user is authorized to access the media stream before streaming the selected media. For example, the application may initially provide each user with a particular amount of credit for access to the media streams (e.g., users initially get 2 free hours of Internet radio). If the application determines that the user is not authorized to access the media stream, the application may prompt the user to purchase access, for example using an approach described below.

In response to receiving a user selection of media stream in media panel 310, media access panel 330 may include several options and representations related to the selected media stream. For example, media access panel 330 may include current media item representation 332 and current media item options 334. The application may identify the current media item transmitted by the media stream using any suitable approach, including for example by monitoring metadata associated with the media stream. Representation 332 may include any image, video, screenshot, icon, or other depiction of the current media item played back by the application. For example, in an Internet radio application, the album cover, title, artist, and playback position of the current song played by the application may be depicted in representation 332. In some embodiments, one or more portions of the representation may be animated or change in real-time (e.g., the playback position cursor of the media item). Option 334 may include any suitable option associated with the current media item. For example, option 334 may include an option to provide a ranking (e.g., a star ranking), view or create a review, notify a friend of the media item, purchase the media item, or any other suitable option. In some embodiments, option 334 may include an option for accessing a media store from which other media items may be purchased.

Media access panel 330 may include several sub-panels for providing recommendations of media items related or not to the current media item. For example, media access panel 330 may include artist panel 336, listeners panel 338, new release panel 340 and top media panel 342. Artist panel 336 may include one or more options, representations, or both of other media items by the same artist as the currently played back media item. For example, artist panel 336 may include one or more representations of songs, albums or compilations by or that include the artist. In some embodiments, the user may select one or more options to view more details about a particular media item by the same author, to purchase the particular media item, or to perform any other suitable operation with the media item.

Listeners panel 338 may include one or more options, representations, or both of other media items purchased by or of interest to other users who purchased or showed an interest in the currently played back media item. For example, listeners panel 338 may include listings of other songs that were purchased by users who purchased the song currently being played back by the selected Internet radio station. The application may use any suitable approach to identify other media items purchased by users who purchased or showed an interest in the current media item. For example, the application may compare records of purchased media items to identify the most common media items purchased by users who purchased the current media item. As another example, the application may identify users who showed an interest in the current media item (e.g., rated the current song highly) and compare the other media items of interest to the identified users to identify the most common other media items of interest. In some embodiments, the user may scroll one or more of artist panel 336 and listener panel 338 to view additional media items.

New release panel 340 may include one or more options, representations, or both of new media items available to the user of the application (e.g., newly released media items). In some embodiments, the user may scroll new release panel 340 to view additional media items. Top media panel 342 may include one or more options, representations, or both of media items that were rated highest or most purchased by some or all users of the application (e.g., most commonly purchased media items over a given time period). In some embodiments, the user may scroll top media panel 342 to view additional media items.

In some embodiments, the application may instead or in addition display other media items related to the current media item using a recommendations panel, or any other display interface. The application may identify other media items related to the current media item using any suitable approach, including for example comparing one or more attributes of the media items (e.g., artist, title, style, genre, release date, or sales figures). In some embodiments, the application may weigh one or more attributes of the current media item to more specifically identify other media items related to the current media item. Because users may have different interests, the application may create different weights, algorithms or both for particular users to provide more personalized recommendations. For example, if a user likes only two artists in a given genre but many more artists in another genre, the application may give a greater weight to the artist names than to the given genre.

In some embodiments, the user's access to streaming media may be taxed. Media access panel 330 may indicate the amount of streamed media remaining to the user (e.g., the amount of streamed media for which the user has paid a tax) using status indicator 335. As the application plays back a media stream, the application may reduce the amount of streaming media remaining to the user (e.g., reduce the credit in a user's account that is associated with the streaming media). Status indicator 335 may indicate the amount of remaining media available to the user using any suitable approach. For example, status indicator 335 may indicate the amount of media streaming time remaining (e.g., 35 minutes), the number of media items that can be streamed, the number of times that the user can access a media stream (e.g., the number of times the user can tune to a radio station), a list of specific available media streams, or any other suitable indicator of the amount of streamed media available to the user. In some embodiments, different media streams may not be taxed equally. For example, premium media streams may be taxed at a higher rate (e.g., more credit is required to access premium media streams). Premium media streams may include, for example, media streams provided by premium media providers (e.g., sports leagues or satellite radio providers). As another example, media streams may be taxed differently based on the type of media provided (e.g., audio or video), or the manner in which media is provided (e.g., standard or high definition).

The user may purchase additional access to streamed media using any suitable approach. For example, media access panel may include purchase option 352, advertisement option 354, and exchange option 356. In response to receiving a user selection of purchase option 352, the application may display a screen for purchasing any suitable quantity of streamed media (e.g., a pop-up window with several options for selecting different amounts of time). In response to receiving a user selection of advertisement option 354, the application may insert one or more advertisements in the media stream, for example between media items. For each advertisement that the user listens to, the application may provide additional access to streamed media. For example, as the user listens to advertisements, status indicator 335 may be updated to reflect the new amount of media streaming time remaining (e.g., the amount of time provided in exchange for listening to the advertisement).

In response to receiving a user selection of exchange option 356, the application may display a screen for purchasing media items in exchange for additional access to a media stream. In some embodiment, the application may display a display screen having similar options in response to receiving a user selection of an option for purchasing a media item from one or more of the other sub-panels of media access panel 330.

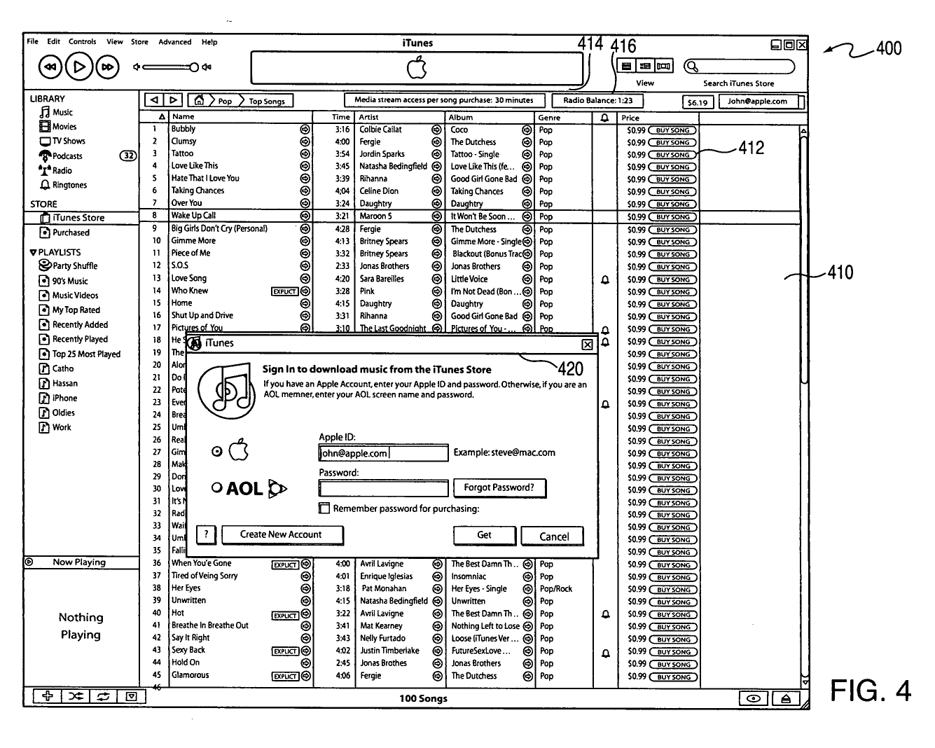

FIG. 4 is an illustrative display screen for purchasing a media item in exchange for access to a media stream in accordance with one embodiment of the invention. Display screen 400 may include listings 410 of media items available for purchase by the user. The media items displayed in listings 410 may include any suitable media items, including for example media items displayed in media access panel 330 (FIG. 3). Listings 410 may include any suitable information for identifying particular media items, including for example the name, artist, length, album and genre of the media item. A buy option 412 that the user may select to purchase a particular media item may be associated with each listing 410.

In response to receiving a user selection of a buy option 412, the application may display login window 420 for the user to authenticate prior to completing the purchase. If the application has previously authenticated the user (e.g., the user had bought a media item and logged in previously), the application may automatically perform the purchase without requiring the user to log in a second time. The user may be required to provide any suitable information to authorize a purchase, including for example a user ID or account ID, a password, purchase information (e.g., credit card information), or any other suitable information.

In some embodiments, a particular amount of streaming media credit that provides the user with a particular amount of media stream access may be associated with some or all of the media items in listings 410. For example, each media item available for purchase may provide the user with the same or different amounts of media stream credit. The application may assign different amounts of credit to different media items using any suitable approach. For example, the application may define different tiers of media items, where each tier provides the user with different amounts of credit. Media items may be assigned to a tier using any suitable approach, including for example based on the price of the media item, the relation of the media item to the media stream, to the currently played back media item, or both, the popularity of the media item, or any other characteristic or attribute of the media items available for purchase. As another example, the application may provide a user with a credit that is related to, for example a multiple of, the length of a particular media item (e.g., provide access to the Internet radio for 2, 5 or 10 times the length of a purchased song).

Listings 410 may include a field for indicating the amount of media stream credit provided in exchange for purchasing a particular media item (e.g., next to the price column). If the credit is the same for each displayed media item, the application may instead or in addition provide a single indication 414 of the credit provided for each purchase. To assist the user in determining whether to purchase a media item to access additional media stream content, display 400 may include balance 416 indicating the credit remaining to the user (e.g., the amount of time remaining for accessing a media stream). The application may determine the user's current balance using any suitable approach, including for example by determining the current balance associated with the user's media stream account.

In some embodiments, the application may provide different prices for media items based on whether or not media stream access is provided in exchange for purchasing the media item. For example, a media item that provides credit for media stream access may be more expensive than the same media item that does not provide media stream credit (e.g., more content available, so more expensive). As another example, a media item that provides credit for media stream access may be less expensive than the same media item that does not provide media stream credit (e.g., the media stream serves for advertising and prompting the user to purchase media items on impulse). This may provide an incentive for users to access media streams, such as for example Internet radio. In some embodiments, listings 410 may include two price columns with different prices, one for purchasing the media item with media stream credit, and one for purchasing only the media item.

In some embodiments, the media stream accessed by the user may be time or place shifted. For example, the electronic device may store or cache a stream that is received, and play back the stored or cached media stream at a later time (i.e., time shifting). As another example, the electronic device may store or cache a stream, and transfer the received stream (e.g., as the stream is received, or at a later time) to a second electronic device, such as for example a portable electronic device (e.g., a portable media player) or a remote device coupled to the electronic device (e.g., a laptop coupled to the electronic device over an Internet connection).

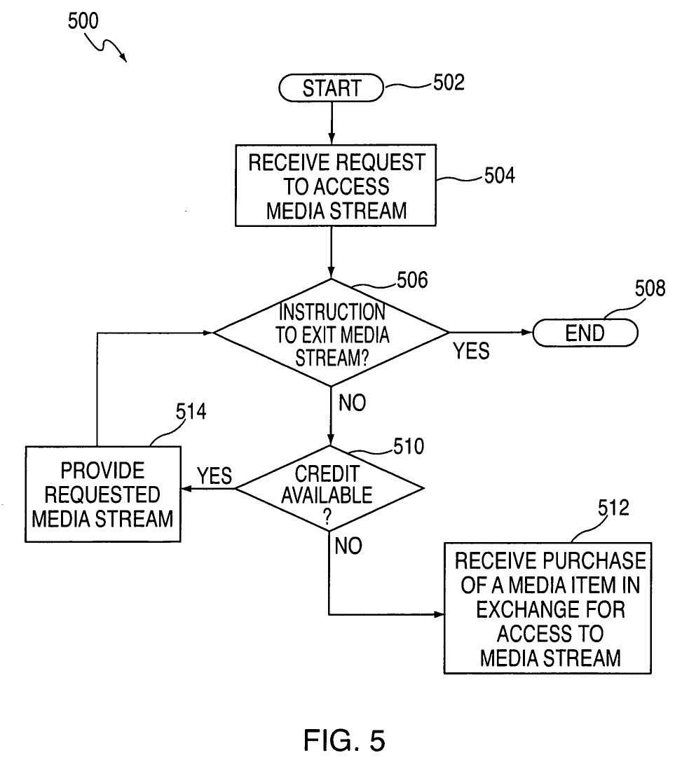

The following flowcharts will describe a number of processes used for purchasing access to a media stream. FIG. 5 is a flowchart of an illustrative process for accessing a media stream in accordance with one embodiment of the invention. Process 500 may begin at step 502. At step 504, the application may receive a request to access a media stream. For example, the application may receive a user selection of a particular media stream (e.g., an Internet radio station) from listings of media streams. As another example, the application may receive an address of a media stream from the user. At step 506, the application may determine whether the user has provided an instruction to exit the media stream. For example, the application may determine whether the user has provided a stop instruction or other instruction to disconnect the media stream. As another example, the application may determine whether the user has provided an instruction to access a different media stream. If the application determines that the user has provided an instruction to exit the media stream, process 500 may move to step 508 and end.

If, at step 506, the application instead determines that the user has not provided an instruction to exit the media stream, process 500 may move to step 510. At step 510, the media application may determine whether the user has sufficient credit available for authorizing access to the media stream. For example, the media application may access the user's account to determine the user's current balance. As another example, the application may review the user's history (e.g., which purchases were made and how many media streams were accessed) to determine whether the user has sufficient credit to access the media stream. If the application determines that the user does not have sufficient credit available for accessing the media stream, process 500 may move to step 512.

At step 512, the media application may receive a purchase of a media item in exchange for access to the selected media stream. The user may view media items for purchase using any suitable approach, including for example by launching a store feature of the application, or by launching a store application associated with the application. The user may purchase any suitable media item in response to accessing the store features. For example, the application may receive a user selection of a media item transmitted by the media stream and played back for the user. As another example, the application may receive a user selection of a media item related to a played back media item (e.g., a user selection of a media item from a media access panel displayed with the media stream). Process 500 may then return to step 510 and determine whether, after the purchase, the user has sufficient credit to access the media stream requested at step 504.

If, at step 510, the application instead determines that the user has sufficient credit available to access the requested media stream, process 500 may move to step 512. At step 512, the application may provide the requested media stream to the user, and output the media items of the media stream for the user. For example, the application may output audio for music transmitted in the media stream (e.g., as Internet radio). As another example, the application may output video for a streamed video provided to the user (e.g., a video clip or on-demand content). As the user receives the requested media stream, the user's balance may progressively diminish. Process 500 may therefore return to step 506 and determine whether a user instruction to exit the media stream was provided and subsequently move to step 510 and check whether the user has sufficient credit to continue accessing the requested media stream.

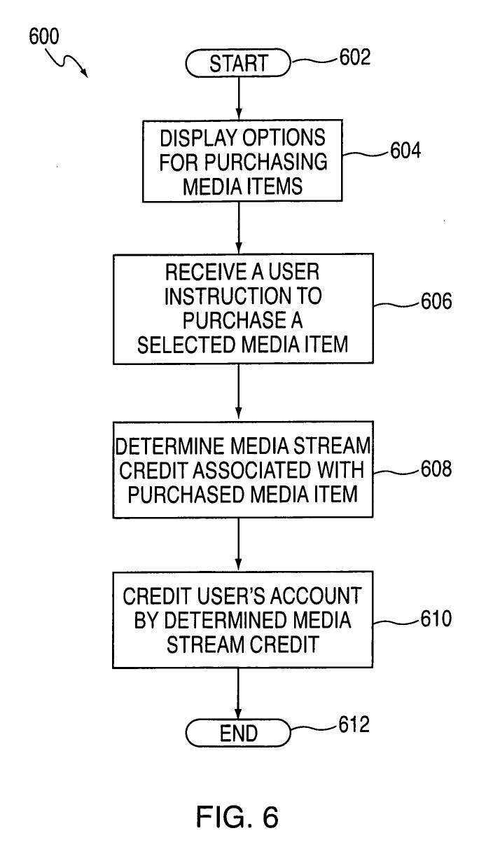

FIG. 6 is a flowchart of an illustrative process for purchasing access to a media stream in accordance with one embodiment of the invention. Process 600 may begin at step 602. At step 604, the application may display options for purchasing media items. For example, the application may display listings of media items available for purchase. The application may display options for purchasing any suitable media item, including for example options for purchasing media items that may be related to a media item currently transmitted by the media stream. At step 606, the application may receive a user instruction to purchase a selected media item. For example, the application may receive a user selection of a displayed media item, and a selection of a corresponding option to purchase the selected media item (e.g., receive a user selection of a buy option associated with a particular listing).

At step 608, the media application may determine the media stream credit associated with the purchased media item. For example, the application may determine the price paid by the user for the selected media item, and determine, based on the price, the amount of media stream credit to attribute to the user's media stream account. As another example, the application may identify one or more attributes or characteristics of the purchased media item, and determine the amount of media stream credit to attribute to the user's media stream account (e.g., determine the length of a purchased song to credit the user with access to Internet radio up to a multiple of the length of the song). At step 610, the application may credit the user's account by the amount of media stream credit determined at step 608. For example, the application may identify the user's account (e.g., based on log-in information provided to purchase the selected media item) and credit the user's balance by the determined amount. Process 600 may then end at step 612.

The above described embodiments of the present invention are presented for purposes of illustration and not of limitation, and the present invention is limited only by the claims which follow.

What is claimed is:

1. A method for providing a user with access to a media stream, comprising:
receiving a user selection of a media stream;
determining whether the user is authorized to access the selected media stream;
in response to determining that the user is not authorized to access the media stream, prompting the user to purchase a media item in exchange for access to the media stream;
receiving a user purchase of a media item; and
providing the user with access to the selected media stream.

2. The method of claim 1, further comprising displaying listings of media items available for purchase.

3. The method of claim 2, further comprising:
identifying at least one attribute of media items transmitted as part of the selected media stream;
identifying a plurality of media items sharing the at least one attribute with the media items transmitted as part of the media stream; and
wherein displaying listings of media items further comprises displaying listings of the identified media items.

4. The method of claim 1, further comprising providing access to the selected media stream in exchange for at least one of purchasing access to the media stream and inserting advertisements in the media stream.

5. The method of claim 1, wherein:
determining whether the user is authorized to access the selected media stream further comprises determining whether an account associated with the user has sufficient credit to authorize access the selected media stream; and
prompting the user to purchase a media item in exchange for access to the media stream further comprises prompting the user to purchase a media item in exchange for adding credit to the user's account.

6. The method of claim 1 further comprising:
playing back the selected media stream;
identifying the media item currently being transmitted by the media stream; and
providing the user with an opportunity to purchase the identified media item.

7. The method of claim 6, further comprising:
identifying a plurality of media items related to the identified media item currently being transmitted; and
providing the user with an opportunity to purchase at least one of the identified plurality of media items.

8. The method of claim 7, further comprising:
receiving a user instruction to purchase at least one of the identified media item currently being transmitted and the identified plurality of media items; and
in response to receiving a user instruction to purchase a media item, crediting a media stream account associated with the user.

9. The method of claim 1, wherein the media stream comprises an Internet radio stream.

10. A method for providing a user with access to a media stream, comprising:
receiving a user purchase of a media item;
crediting an account associated with the user in response to receiving the user purchase of the media item, wherein access to the media stream is provided in exchange for credit in the user's account;
receiving a user request to access the media stream; and
playing back the media stream in response to receiving the user request.

11. The method of claim 10, further comprising, in response to receiving the user request for access to the media stream, determining whether the user's account has sufficient credit to authorize access the media stream.

12. The method of claim 10, further comprising decreasing the credit in the user's account as the user plays back the media stream.

13. The method of claim 12, further comprising:
monitoring the amount of credit remaining in the user's account;
determining that the remaining credit is insufficient to continue playing back the selected media stream; and
prompting the user to purchase additional credit.

14. The method of claim 13, wherein prompting the user to purchase additional credit further comprises prompting the user to purchase a media item in exchange for additional credit.

15. The method of claim 14, further comprising displaying recommendations of media items available for purchase in exchange for additional credit.

16. The method of claim 14, further comprising providing the user with an opportunity to purchase the media item at a first price in exchange for additional credit, and at a second price without additional credit.

17. An electronic device for receiving a media stream, the electronic device comprising control circuitry and an input mechanism, the control circuitry operative to:
receive a user request from the input mechanism to access a media stream;
determine that the user does not have sufficient credit in the user's media stream account to access the media stream;
receive a user selection of a media item to purchase from the input mechanism, wherein the media item is associated with media stream credit;
credit the associated media stream credit to the user's media stream account in response to the user purchasing the selected media item; and
accessing the requested media stream.

18. The electronic device of claim 17, wherein the control circuitry is further operative to decrease the amount of credit in the user's media stream account in response to accessing the requested media stream.

19. The electronic device of claim 17, wherein the control circuitry is further operative to:
display an option for purchasing a media item, wherein the media item is related to the currently accessed media stream; and
receive a user selection of the option to purchase the media item from the input mechanism.

20. The electronic device of claim 19, wherein the control circuitry is further operative to credit the user's media stream account in response to receiving the user selection of the option to purchase the media item.

21. A method for purchasing credit for a media streaming account, the method comprising:
identifying a media streaming account, wherein access to a media stream is provided in exchange for credit from the media streaming account;
receiving a user selection of a media item for purchase, wherein the media item is associated with media streaming credit;
determining the amount of media streaming credit associated with the selected media item; and
crediting the user's media streaming account with the determined amount of media streaming credit in response to receiving the user selection of the media item for purchase.

22. The method of claim 21, further comprising:
receiving a user purchase of a particular amount of streaming media credit; and
crediting the user's media streaming account with the particular amount of media streaming credit.

23. The method of claim 21, further comprising:
receiving a user selection of a media stream;
accessing the selected media stream; and
debiting the user's media streaming account in response to accessing the selected media stream.

24. The method of claim 23, further comprising:
determining that the user's media streaming account does not include sufficient credit to continue accessing the selected media stream; and
exiting the selected media stream.

25. The method of claim 21, wherein the media stream comprises an Internet radio stream.
